(19) United States
(12) Patent Application Publication
(10) Pub. No.: US 2019/0178321 A1
(43) Pub. Date: Jun. 13, 2019

(54) ELECTROHYDRAULIC ACTUATING DEVICE WITH COOLING MODULES

(71) Applicant: EMG AUTOMATION GMBH, WENDEN (DE)

(72) Inventor: ACHIM KIEFEL, DERSCHEN (DE)

(21) Appl. No.: 16/309,910

(22) PCT Filed: Jun. 1, 2017
(86) PCT No.: PCT/EP2017/063281

§ 371 Date: Dec. 13, 2018

(30) Foreign Application Priority Data
Jun. 13, 2016 (DE) 10 2016 110 779.4

(51) Int. Cl. F16D 65/78; F16D 65/16; F15B 11/10; F15B 21/0423; H02K 5/18

(52) U.S. Cl. CPC F16D 65/78; F16D 65/16; F15B 11/10; F16D 2125/08; H02K 5/18; F16D 2250/0023; F15B 21/0423

(57) ABSTRACT

An electrohydraulic actuating device (10), having an electric motor (1) and having a pump (2) driven by said electric motor, for the operation of a hydraulic control cylinder (8) of a hydraulic unit (3) wherein the motor (1) and the hydraulic unit (3) are each accommodated in a housing part (21, 22) of a housing (20), and wherein the housing (20) is equipped, at least in sections, with outwardly pointing cooling fins (4), wherein the housing (20) has a cuboidal or rectangular cross-sectional shape with substantially straight wall sections (23) situated at least on two opposite sides, which wall sections are formed with planar depressions or cutouts (24) which are continuous in the longitudinal direction, and the cooling fins (4) are provided at least partially in the form of removable plate-like cooling modules (5) which, for the insertion and installation thereof, are adapted in terms of shape and depth to the depressions or cutouts (24) of the housing (20).

This invention is for an electrohydraulic actuator with an electrical engine and hydraulic pump to operate the hydraulic control cylinder of a hydraulic unit, as in the preamble to claim 1. Such electrohydraulic actuators are used in positioning various devices and equipment. The invention is, in particular, designed for electrohydraulic actuators used as so-called air braking devices in brake systems and devices for braking crane systems, for example. The electrohydraulic braking device has an electrical engine and hydraulic unit connected to the electrical engine. The hydraulic unit comprises a hydraulically-actuated positioning cylinder operated by a suitable control unit. The hydraulic unit, in addition, comprises a tank module and corresponding ducts or lines for hydraulic fluid. The hydraulic unit also comprises such actuators, hydraulic valves and control components as serve to operate the actuator in conjunction with the control unit.

This invention relates, in particular, to such electrohydraulic actuators which have housing to accommodate both the hydraulic unit and the electrical engine. The housing, which is of compact design, accommodates the various electrohydraulic actuator components and modules. With previous versions, such housings are, made for electrohydraulic actuators, owing to the high level of demand in terms of strength and heat resistance protection against external damage usually comprising housings, in two or three sections, of moulded components. The cast-metal housings are then machined and interconnected using appropriate connecting devices, such as screws. To ensure that the heat generated inside the electrohydraulic actuators is ablated sufficiently, the sections of housing for such electrohydraulic actuators are equipped, at least in sections, on the outside, with cooling fins. Making cooling fins by moulding, however, proves to be difficult; and the minimum wall thicknesses when moulding such housings for electrohydraulic actuators are relatively large which, through doing so, makes ablating heat difficult. On the other hand, the previous version for such air-braked equipment also uses housings comprising multiple individual parts of a plate-like metal material; but air-braked equipment housings made using this method often lack the strength required in the operating conditions found in practice. On the one hand, there were solutions for such housings for electrohydraulic actuators which were very expensive to make and each of which required different tools for the different sizes and shapes of these devices, such as with housings made out of castings. On the other hand, housing solutions were proposed in which a multiplicity of different components had to be made and interconnected, which proved to be considerably disadvantageous in terms of strength and stability.

With this in mind, the issue for this invention, is to provide an electrohydraulic actuator, particularly for use as air-braked equipment which in view of the multiplicity of variants of different sizes and designs of such devices, is optimised with respect to the housing and which enables heat to be ablated effectively from inside the device. It should also be possible to make the electrohydraulic actuator in the invention at a comparatively low production cost in terms of the housing.

This issue is solved by using an electrohydraulic actuator with the characteristics described in claim 1. Advantageous design features of, and extensions to, the invention are the subject of the dependent claims.

In the invention, an electrohydraulic actuator with an electrical engine and a pump driven by the latter is installed to operate the hydraulic actuator cylinder of a hydraulic unit, where both the electrical engine and the hydraulics are accommodated in a section of the housing in the device, and where the housing is equipped, at least in sections, with externally-pointing cooling fins, a characteristic of which is that the casing is of a cuboidal or rectangular cross-section shape, with essentially straight wall sections on at least two opposite sides, installed with level depressions or cut-outs which are continuous in a lengthways direction, and that the cooling ribs are equipped, at least in part, with detachable, plate-like cooling modules the form and depth of which are tailored for fitting and mounting to the depressions or cut-outs in the housing.

The actuator housing is thus made in an essentially cuboidal or rectangular form, providing a compact design, with flat outer walls. Thus, in the electrohydraulic actuator in the invention, the housing comprises a section of housing for the hydraulic unit and a housing section for the electrical engine to which it is connected. The two parts of the sections of housing together form the compact block-shaped complete housing of the actuator. The block-like or rectangular form of the device housing in the invention has at least two opposite, essentially straight, wall sections formed with level depressions and/or cut-outs on the outside, which are continuous in a lengthways direction. The depressions or cut-outs in at least two (preferably opposite) wall sections can be used to insert plate-like cooling modules, these cut-outs are equipped with a multiplicity of cooling fins.

The depressions or cut-outs in the straight sections of the housing can also be used to install additional fittings, devices and components at the factory, such as sensors, switches, and the like. Once the plate-like cooling modules are fitted, these add-on components are fully concealed externally and cannot then be accessed in that state. It is only by removing the dockable cooling modules, with the multiplicity of coolant fins, that these components or their connections can be accessed again. The outward form of the electrohydraulic actuator casing is thus essentially fully enclosed and offers no points of attack at which it could be damaged, etc, but it allows for a wide range of actuators to be used in the level depressions or cut-outs, as required, to suit the demands of different parts, components, etc.

The invention also has the advantage that the detachable, plate-like cooling modules can be used simply and easily to meet different requirements in terms of heat ablation. Certain applications may require greater cooling power, with cooling modules optimised for that purpose, for example, whereas other areas of use may not require such optimised heat ablation. Not least, the electrohydraulic actuator in the invention can be used to make actuators of different sizes and lengths, irrespective of the shape of the tool used. The housing sections in the block-like housing can be easily made using one and the same production device and one and the same tool in different lengths or in a standard length tailored to the size required. This considerably simplifies the construction of the housings of air-brake equipment and/or electrohydraulic actuators such as this. Designing the cooling modules and cooling fins on the plate-like cooling modules separately, or at least in sections, also has the advantage that, in terms of materials, it is possible to respond specifically to specific requirements, both in terms of the sections in the housing and the cooling effect of the cooling modules.

Not least, the detachable, plate-like cooling modules can easily be removed to carry out maintenance or make alterations to the inner structure of the hydraulic or electrical components, etc; and the cooling modules can easily be replaced if they are damaged, without needing to change the whole housing.

The advantageous design feature of the invention gives the electrohydraulic actuator cooling modules a flat back on the side of the housing. Externally-pointing parallel cooling fins are installed on the housing, and run continuously along the entire length of each section of the housing, i.e. the section housing the electrical engine and that housing the hydraulic unit, or over either one of the two sections of housing. The flat-backed cooling modules can be fastened securely and safely to the cut-outs and/or depressions in the housing. The overall-surface level fitting also has the advantage of ensuring that heat can be conducted well to ablate it from the hydraulic fluid externally, away from the housing.

The outward-pointing cooling fins are arranged in parallel, forming plate-like cooling modules with a large-scale cooling unit, with fins above, and gaps between them, through which the cooling air can flow. In the invention, the cooling fins and, hence, the cooling module are installed across the entire length of the housing section, i.e. they extend uninterruptedly from top to bottom. The coolant fins are thus spaced with open gaps between them, upwardly and downwardly from the housing, enabling good heat ablation. This also makes the production process much simpler, as the cooling modules may also be made through extrusion or extrusion moulding.

In a further advantageous design feature of the invention the cooling fins within a cooling module are of different heights and/or point in different directions. The cooling fins of a cooling module may be made at different depths, depending on where they are located or positioned across the housing. Thus, those cooling fins located further outwards may be higher (or deeper) than those located cerarally. The cooling fins may also be arranged in different directions within the cooling module. Both measures may be used to respond specifically to the cooling requirements of a particular electrohydraulic actuator, so the inner hydraulic and electrical components may be cooled differently and specifically at different points.

In yet another advantageous design feature of the invention, coolant fins inside a cooling module are aligned coaxially in direction x in which the electrohydraulic actuator moves when working. The direction of travel of an electrohydraulic device in operation, i.e. how a piston cylinder unit travels, is normally lengthways to its housing. In the invention, the cooling fins also point in this direction, i.e. they are installed coaxially to the working direction. Aligning the cooling fins lengthways to the working direction makes installing the sections of housing even easier, so heat ablates well in all areas of the housing section. Heat-ablating components are virtually uninterrupted lengthways along the outside of the housing of the actuator.

In one further advantageous design feature of the invention, the sections in the housing for the electrohydraulic actuator are made as extrusion-moulded sections. The form and compact design of the sections of housing in the invention makes it possible to create sections of housing using extrusion moulding. The extrusion-moulded sections make it possible to create sections of housing of different lengths and hence, actuators of different sizes, depending on the purpose and design required: so one and the same extrusion moulding tool may be used to make a multiplicity of different variants of such sections of housing for electrohydraulic actuators.

In yet one more advantageous design feature, the cooling fins in the cooling modules of the electrohydraulic device are installed in such a way as to form an outward-opening gap for the cooling module: so, rather than the cooling fins being enclosed in an outer cover, they are freely accessible externally to passing cooling air, which improves the cooling effect and enables the cooling module to be made of more compact, i.e. smaller, design for the same cooling effect. The cooling fins may, for example, be equally spaced on a plate-like cooling module so as to form an even cooling space with equally large gaps between the individual cooling ribs. Alternatively, the cooling fins may be installed at varying distances and made to point in different directions to the plate-like cooling module.

In yet, another advantageous design feature in the invention, the cooling modules in the housing for the electrohydraulic actuators are turned into extrusion-moulded sections. In the invention, the cooling fins are installed continuously in the level depressions and/or cut-outs in the housing, i.e. there are no interruptions in the particular section of housing section, and the cooling modules can be advantageously turned into extrusion-moulded sections, thus reducing the cost, as the same extrusion moulding tool can be used for the cooling modules of different lengths of different actuators. The cooling modules are preferably made of a metallic material such as aluminium alloy; alternatively, they can be made of a suitable material for providing a cooling effect, which is sufficiently heat-resistant at particular temperatures and has a good coefficient of thermal conduction for ablating heat from the inside of the devices.

In another advantageous design feature of the invention, the cooling modules with cooling fins in the housing are made of a different material to that of the housing. The housing may, for example, be made of a raw material strong enough to withstand prevailing pressures, whereas the cooling modules with the cooling fins are made of a different secondary material which is not as strong but is a good heat conductor.

In another advantageous design feature of the invention, the sections of the housing for the actuator are closed off with end covers in each case, which have the same circumferential cross-section as the housing. The end covers of the housing for the actuator in the invention thus close off the respective sections of housing where the continuous external form and/or cross-section form is also maintained on the sides of the covers. From this viewpoint, the covers may be arranged as simple plate-like components tailored to the respective outer circumferential form of the sections of housing. This means that the essentially cuboidal or block-shaped design of the housing is also used in the covers and in any lateral depressions in the housing wall, and the fin shapes continue into the relevant housing cover. This enables the housings to be closed off simply and safely; and the external form and design of the sections of housing for the actuator extends across the covers at the respective ends of the openings in the housing.

In a further advantageous design feature of the invention, the level surfaces of the depressions or cut-outs in the housing are installed with connections and fittings to connect components, particularly add-on devices. Such connections and/or fittings enable the electrohydraulic actuator to be adapted specifically to each application: the various sensors, switches and components may be fitted to the rear of the cooling module, i.e. to the level surfaces in the housing, simply, for example. Once the cooling modules, with their outwardly-projecting cooling fins, have been fitted, these add-on parts and equipment connections are no longer visible and accessible from the outside, making the devices more reliable. This can also prevent them from being accidentally manipulated or damaged. The different connections and fittings for attaching components also have the advantage that the same housing form can be used for different variants of the actuators. Not using one or more of the connections and fittings present can no longer be seen on the finished product because they are covered by the cooling modules. The different variants may thus be made simply and easily with less effort and at a lower cost of production; and the detachable cooling modules in the invention may also be used to retrofit add-on components which were not fitted originally at the factory.

In a further advantageous design feature of the invention, cooling modules are available as the material and/or form and length of the cooling fins, as variable, interchangeable modules for one and the same actuator. This also increases variability in production without significantly increasing production costs. The cooling modules may be fitted to the respective housing fittings and removed again depending on the requirements and operating conditions concerned. The different materials and different shape and/or orientation and length of the cooling fins may also be adapted to current conditions using the devices in operation. This adaptation may be done extremely easily from outside; and the actuators need not be designed differently in terms of the form of their housings.

In a further advantageous design feature of the invention, the cut-outs and/or depressions for the cooling modules are installed in a central area in the width of the housing, excluding the edge area, and the shape and orientation of the cooling fins are symmetrical with respect to a centre line in the housing.

Arranging and dividing the cooling fins, starting symmetrically from the central area of the housing, has the advantage that the hotter areas of the housing are well cooled, whereas the edge areas further away from the centre have a reduced cooling effect which is not needed there either. The stability and strength of the housing, including that with respect to external effects are, however, guaranteed as the cooling module cooling fins are installed solely in a central area on the outside of the housing.

In a further advantageous design feature of the invention, the cooling modules in the housing are given an externally-shaped, stomach-like curve. While the back of the cooling modules in the invention is a level surface, in this advantageous design feature, the front sides of the cooling modules are curved outwards, resulting in the cooling fins potentially varying in length and/or projecting away from the housing in different strengths. The stomach-like form nonetheless has the advantage of the essentially cuboidal or rectangular housing having a kind of curved shape in the cooling modules tailored to the prevailing heat distribution inside the actuator. The curved shape means that the cooling fins on the sides are closer to the central point than those in the central area of the cooling modules. This measure takes account of the heat distribution

In the housing, so the cooling effect is further optimised accordingly.

In another advantageous design feature of the invention, the actuator has a control/interface unit with connections and control components fitted to the engine housing section without it projecting beyond the outer circumference of the housing, section of the hydraulic unit. The control/interface unit in the invention is thus enclosed within the broadest external circumference of the actuator. It does not, therefore, form a disturbing projecting component, as was the case in the previous version. In the previous version with housings of actuators such as these, made from cast sections, the actuator's control/interface unit was usually a component attached to the outer circumference of the hydraulic unit casing; but such a projecting external control component runs the risk of being damaged by external components under certain operating conditions. The control/interface unit in the invention, on the other hand, is also enclosed in the outer circumference of the (broader) housing section of the hydraulic unit. This gives a very compact design as a whole, minimizing the risk of damage while maintaining good accessibility for connecting the electrohydraulic actuator locally.

In a further feature of the invention, the sections of housing are positioned coaxially to the working direction of movement and to one another. That is to say, the two sections of housing lie in line on the same plane, making the external form a continuous, more compact, block.

The invention will be described in more detail and better understood below, where a detailed description of preferred design features follows, with references made to the drawings, in which:

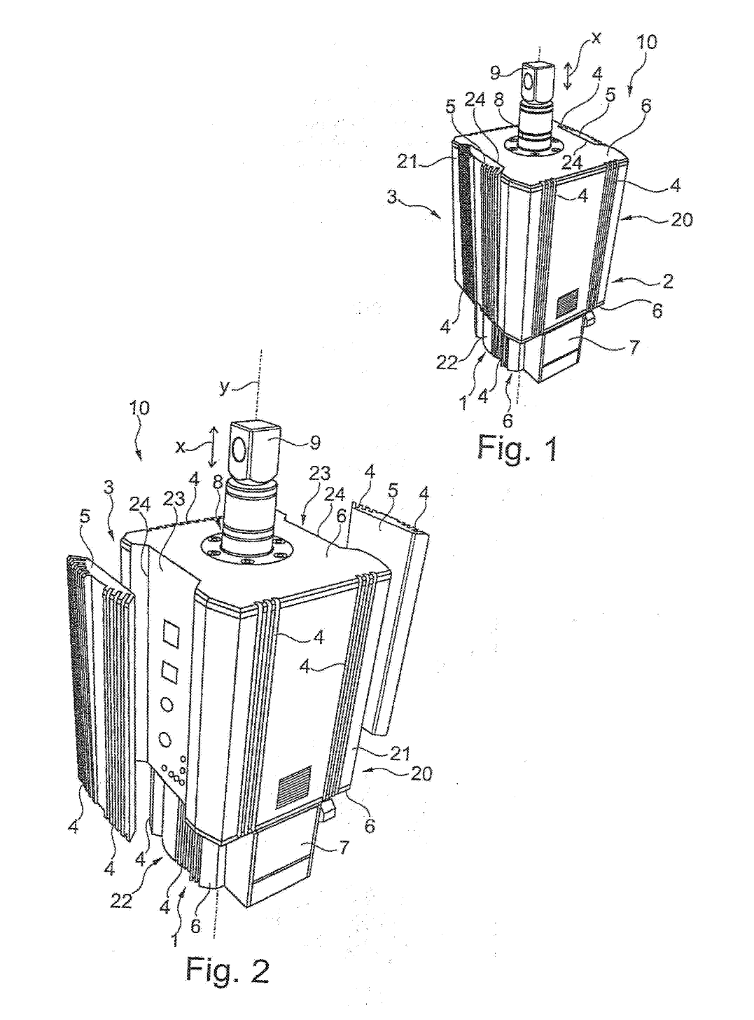

FIG. 1 shows a perspective view from above of a first design feature in the invention of an electrohydraulic actuator as assembled;

FIG. 2 shows an exploded perspective view from above of the first design feature in the invention with cooling modules removed;

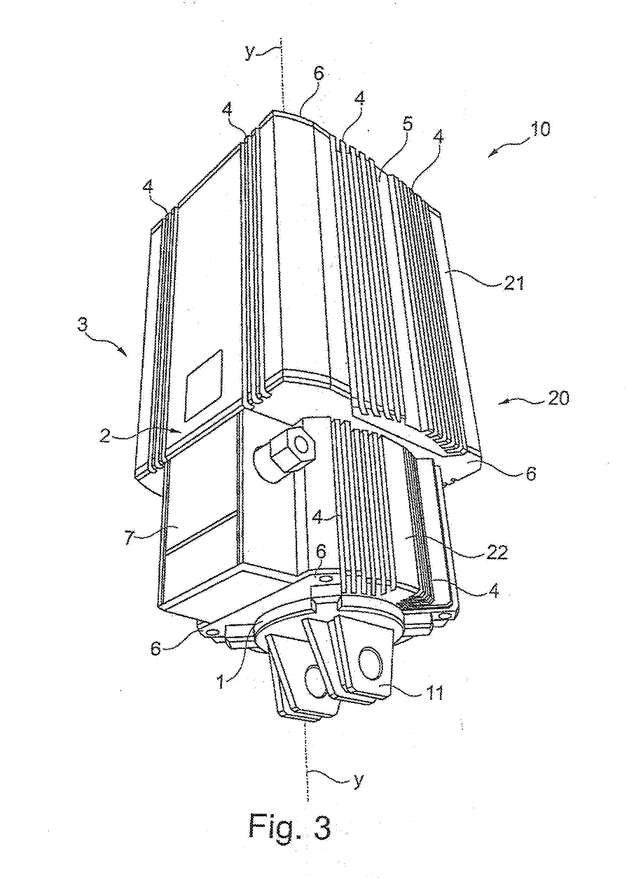

FIG. 3 shows a perspective view from below of the first design feature of an electrohydraulic actuator in the invention;

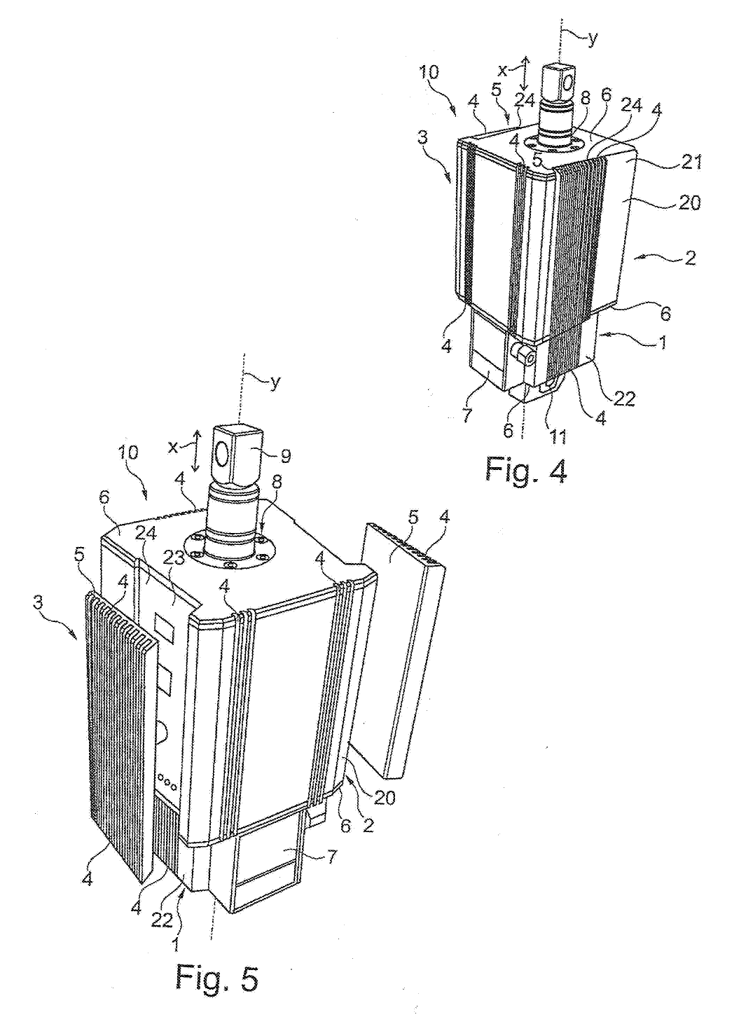

FIG. 4 shows a perspective view from above of a second design feature of an electrohydraulic actuator in the invention as assembled;

FIG. 5 shows an exploded perspective view from above of the second design feature of the invention with the cooling modules removed; and

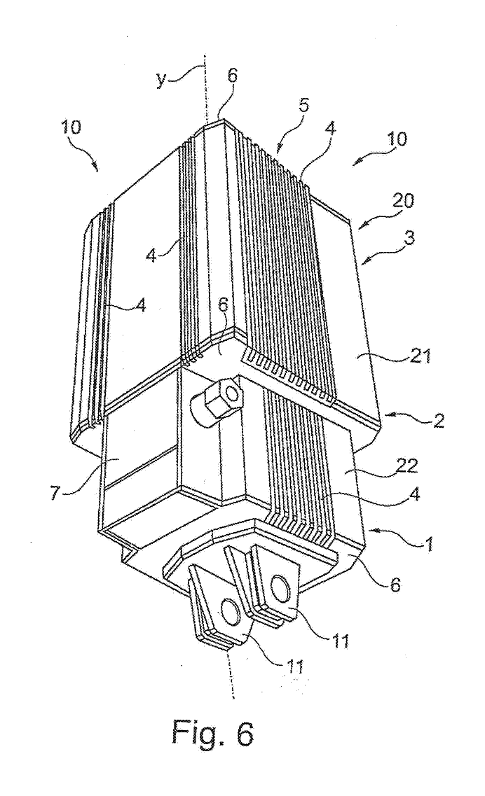

FIG. 6 shows a perspective view from below of the second design feature of an electro-hydraulic actuator, as assembled.

FIGS. 1 to 3 show different perspective views of a first design feature of an electrohydraulic actuator 10 in the invention. FIG. 1 shows actuator 10 in a perspective assembled view from above, FIG. 2 shows the same design feature with cooling modules 5 removed, and FIG. 3 shows a further perspective view of electrohydraulic operating device 10 of this first design feature, this time from below.

In the first design feature, electrohydraulic actuator 10 comprises a housing 20 in an essentially cuboidal/square cross-sectional form with a first housing section 21 for a hydraulic unit 3 in the upper area and a second housing section 22 below it for electrical engine 1. The two sections of housing 21, 22 of block-like housing 20 are arranged coaxially to one another and coaxially to working direction x of actuator 10. In particular but not necessarily, actuator 10 is what is known as an air-braked device which serves to make braking systems work on a fail-safe basis, such as in cranes or lifts, for example. Electrohydraulic actuator 10 The invention is characterised by a particular design of housing 20 in a block-like and/or cuboidal form, where at least two essentially straight wall sections 23 are installed on the outside of housing 20, in the present example merely on housing section 21 of hydraulic unit 3. Straight wall sections 23 of housing 20 are made from cut-outs and/or depressions 24 which extend in level form continuously over the whole length of upper housing section 21. These depressions and/or cut-outs 24 serve to take cooling modules 5 In the invention as the exploded presentation in FIG. 2 shows.

Cooling modules 5 have a multiplicity of cooling fins 4 on a plate-like cooling module 5, where the level rear is tailored to the shape and size of depression 24 on level wall section 23 of housing 20. Cooling fins 4 serve to cool sections of housing 21, 22 which, heat up due to the internal processes within actuator 10. Electrical engine 1, installed in lower housing section 22, drives a hydraulic pump 2 of hydraulic unit 3 which in turn is contained in upper housing section 21. Inside hydraulic unit 3, hydraulic pump is connected to a positioning cylinder 8 which is actuated via corresponding controls, valves and ducts inside hydraulic unit 3, as indicated in the figures, by working direction x. Positioning cylinder 8 has a bearing sleeve 9 at the upper end of actuator 10 to connect to the systems to be actuated, such as braking systems. On the underside, as can be seen, in FIG. 3, there is a foot attachment 11 with two flange-like projections and a through-hole through which actuator 10 is installed. Electrical engine 1 is housed in the lower narrower housing section 22 of housing 20, where housing section 22 is installed with cooling fins 4 at a dog-leg-projecting wall section of the housing. These cooling fins 4 ablate the waste heat from electrical engine 1 out from the housing to the ambient air. The lower housing section 22 of electrical engine 1 is closed off with a cover 6 downwards on the underside. On one side of electrical engine 1, an interface/control unit 7 is installed to which actuator 10 is connected electrically and hydraulically.

In the invention, upper housing section 21 of hydraulic unit 3, whose external dimensions are broader, is installed in an essentially cuboidal, block-like shape with four-side walls, where at least two opposite side walls are designed essentially identical. In this example, two opposite walls, Sections 23 of upper housing section 21 have two cut-outs and/or depressions 24 which serve to take detachable cooling modules 5 as shown in the exploded view in FIG. 2. Depressions 24 for cooling modules 5 are made in a central area over approx. two thirds of the width of level wall section 23 of upper housing section 1.

In this design feature in FIGS. 1 to 3, depression 24 is installed with angled side walls in a kind of V-shape which match the corresponding shape of cooling module 5 with cooling fins 4. Cooling modules 5 are attached as detachable components to housing 20 of actuator 10. Cooling modules 5 with cooling fins 4 may be removed through it, where required, such as to fit add-on components to the housing. Detachable cooling modules 5 also have the advantage that they can be exchanged for different purposes and operating conditions, and they can also be replaced if cooling fins 4 are damaged. One considerable advantage of the modular construction of housing 20, however, is that the same housing 20 can be used for different variants and model types, as detachable cooling modules 5 and the constant, continuous cross-sectional form of the sections of housing enable different types of hydraulic units and engines to be used in the same housing.

Cooling modules 5 with their respective rows of right cooling fins and left cooling fins as in the first design feature are installed in a curved, projected form such that central cooling fins 4 in cooling module 5 are shorter than the lateral cooling fins 4 (cf. FIGS. 1 and 2). As well as detachable cooling modules 5, further cooling fins 4 are also installed in the other side walls and on lower housing section 22 installed for engine 1 which are formed in the housing walls, i.e. not as detachable cooling modules 5, but as fixed cooling fins 4. Alternatively, they may also be made as detachable modules; however, in the invention, sections of housing 21 and 22 are made out of extrusion-moulded sections, and thus have a continuous, constant cross-sectional form over their whole length: so, the same tool in the extrusion moulding device can be used for different size actuators 10 which reduces production costs considerably and enables a much broader range of variants of actuator 10. Altogether, the form of housing 20, as in the invention, with covers 6, and the flat side walls make for a very compact design. Actuators 10 are shown to be compact, block-like components, such as connections for sensors, switches, etc, which have no components, including connections for sensors, switches, etc. projecting problematically outwards. Even interface and control unit 7 is integrated with the compact design without problematically projecting further outwards than the broadest housing section 21.

FIGS. 4, 5 and 6 show different views of a second design feature of an actuator 10, as in the invention. In terms of its inner structure and components, namely hydraulic unit 3 and electrical engine 1, the second design feature is essentially identical to the first. The second design feature of the invention differs from the first in that the form of housing 20 and the position and form of cooling modules 5 are different.

Once again, housing 20 of electrohydraulic actuator 10 is made in a cuboidal or square cross-sectional shape, where sections of housing 21, 22 are made as extrusion-moulded sections. Here again, housing 20 is divided into an upper, broader, housing section 21 to accommodate hydraulic unit 3, including hydraulic pump 2 and positioning cylinder 9 and a second housing section 22 to accommodate electrical engine 1, which drives hydraulic pump 2 of hydraulic unit 3. As with the first design feature, the second design feature in the invention has continuous, constant cross-section forms of the respective sections of housing 21, 22 so it can be made using extrusion moulding. Cooling fins 4 for cooling modules 5 and fixed cooling fins on the fiat exterior to housing 20, as the outer surfaces of the wall sections of housing 20, remain continuously constant over the straddling of/respective sections of housing 21, 22. This is also the case with the two opposite flat wall sections 23 where the cut-outs and/or depressions 24 are installed to take cooling modules 5. As in the first design feature, in level wall section 23 of cut-outs/depressions 24, a series of connections and openings shown in FIG. 5 are installed in housing 20 in which connecting parts and different sensors and/or switches can be installed for actuator 10. The connections and fittings can also subsequently be used for maintenance purposes or to subsequently change add-on parts. In addition, cooling modules are installed as plate-like components with a flat rear to connect to the relevant depression and/or cut-out 24 and which are formed externally with a projecting row of cooling fins 4. Unlike with the first design feature, in this second design feature, cut-outs/depressions 24 are asymmetrical around centre line Y but are displaced unilaterally to housing 20. Correspondingly, cooling modules 5 are installed in a laterally-displaced position on the respective outer walls of housing 20. In this second design feature, cooling module 5 is not, in and of itself, symmetrical, but is installed as a conically-extending component, longer on one side and/or with higher cooling fins than on the other side. Correspondingly, cut-outs and/or depressions 24 in wall sections 23 are formed in such a way that they are shallower in the central area than on the edge of housing 20, as is clearly shown in FIGS. 5 and 6 in particular. In this second design feature, the form of housing 20 with the two sections of housing 21, 22 of actuator 10 is selected so as to give a compact component as a whole with smooth, level outer wall sections. The connecting components are integrated in compact housing 20 and covered partly by cooling modules 5 and/or contained in interface/control box 7 which is also installed as an integrated and essentially non-projecting component.

In the second design feature, actuator 10, as in the invention, is also characterised by a larger multiplicity of variants in the essentially constant outer form of sections of housing 21, 22. Different types of actuators and different sizes and/or lengths of such actuators 10 may be made with one-and-the-same extrusion moulding tool, as the form and design of housing sections 21, 22 are adapted specifically to this type of production.

Not least, the design of actuator 10, with its compact cuboidal housing 20, is optimised specifically to ablate heat from units inside. As far as both electrical engine 1 and hydraulic unit 3 are concerned, however, in the broad area, arranged with cooling fins 4, particularly with cooling modules 5, the fixed, fitted cooling fins 4 also ablate heat and cool the actuating device considerably better than the previous version.

In an alternative design feature of the invention, cooling modules 5 are attached to housing 20 using spacers. This enables the add-on equipment and components fitted behind the cooling modules to be covered by frontally-positioned cooling modules 5. The inner contour of the actuator housing is thus covered continuously from the outside and can be fully used for cooling purposes through the cooling modules and the internally-installed cooling fins. The spacers between the housing and/or the depression in the housing and the cooling modules are preferably installed in a form and using a material which is a good heat conductor.

In a further alternative design feature of the invention, a fan unit is installed to assist the cooling effect. The fan unit (not shown in the figures) is integrated in housing section 22 of engine 1, for example, and has ventilation openings which point in the direction of the cooling fins 4. The fan unit may also be inserted as a separate module between housing section 22 of engine 1 and housing section 21 of hydraulic unit 3, where it preferably has the same cross-sectional form and external contours as the other sections of housing. In a further aspect of the invention, cooling modules 5 with cooling fins 4 may have am external, plate-like cover such that the gap installed between cooling fins 4 is sealed externally. This guides the cooling air in a kind of forced flow, preferably assisted by a fan from a fan unit.

In a further advantageous design feature of the invention, cooling fins 4 of cooling modules 5 are installed such that they are flush with the adjacent outer walls of the respective sections of housing 21, 22: thus, there are no projecting cooling fins on the outside of housing 20. An alternative in this invention is that, rather than cooling fins 4 being flush, they project slightly in relation to the adjacent wall sections of housing 20.

In a further design feature of the invention, heat-conducting equipment is installed between cooling modules 5 and housing 20. Heat-conducting foils or a heat-conducting paste is applied at the points where cooling modules S connect to housing 20, for example.

The invention is not limited to the characteristics of the design features shown and includes further derivations and modifications within the scope of the appended claims.

The form and design of detachable and/or connectable cooling modules 5 may differ from those in the examples shown. Cooling modules 5 may be connected to housing 20 in different ways, preferably via detachable connections including bolts, or the like.

The external cuboidal fount of housing 20 of actuator 10, as in the invention may also vary, as long as it is of essentially cuboidal or block-shaped construction. The edge areas may or may not be slightly bevelled. The constructions presented in the design features above may, however, also vary in terms of the position and arrangement of cooling fins and cooling modules.

1. Electrohydraulic actuator (10) with an electrical engine (1) and pump (2) driven by this to operate a hydraulic positioning cylinder (8) of a hydraulic unit (3), where engine (1) and hydraulic unit (3) are each contained in a housing section (21, 22) of the housing (20) and where the housing (20) is installed with outwardly-pointing cooling fins (4), at least in sections, characterised in that the housing (20) has a cuboidal or rectangular cross-sectional form with essentially straight wall sections (23), at least on two opposite sides, which are formed with depressions or cut-outs (24) which are continuous in a lengthways direction, and that cooling fins (4) are installed at least partially in the form of detachable, plate-like cooling modules (5) the shape and depth of which are matched in inset and fitting to the depressions or cut-outs (24) in the housing (20).

2. Electrohydraulic actuator (10), as in claim 1, characterised in that the cooling modules (5) have a flat-backed housing side and parallel cooling fins (4) pointing parallel from the housing (20) which run continuously over the whole length of each housing section (21, 22).

3. Electrohydraulic actuator (10), according to claim 1, characterised in that the cooling fins (4) within a cooling module (5) are of different heights and/or directions.

4. Electrohydraulic actuator (10), according to claim 1, characterised in that the direction of fins (4) is coaxial to working direction x.

5. Electrohydraulic actuator (10), according to claim 1, characterised in that sections of housing (21, 22) are made as extrusion-moulded sections.

6. Electrohydraulic actuator (10), according to claim 1, characterised in that the cooling fins (4) form an externally open gap of cooling modules (5).

7. Electrohydraulic actuator (10), according to claim 1, characterised in that the cooling modules (5) are made as extrusion-moulded sections.

8. Electrohydraulic actuator (10), according to claim 1, characterised in that the cooling modules (5) are made from a different material from the housing (20).

9. Electrohydraulic actuator (10), according to claim 1, characterised in that sections of housing (21, 22) are sealed with end covers (6) which have a circumferential cross-sectional form essentially identical to the housing (20).

10. Electrohydraulic actuator (10), according to claim 1, characterised in that the flat surfaces of depressions or cut-outs (24) of housing (20) are installed with connections and/or slots for attaching components and add-on devices, in particular.

11. Electrohydraulic actuator (10), according to claim 1, characterised in that cooling modules (5) are installed in terms of the material and/or form and length of cooling fins (4) as variably interchangeable modules for the same actuator (10).

12. Electrohydraulic actuator (10), according to claim 1, characterised in that the depressions or cut-outs (24) are installed in a central area of the width of the housing (20), excluding an edge area, and that the form and orientation of cooling fins (4) are symmetrical with respect to a centre line Y for housing (20).

13. Electrohydraulic actuator (10), according to claim 1, characterised in that cooling modules (5) are shaped in an external, stomach-like curve.

14. Electrohydraulic actuator (10) according to claim 1, characterised in that a control/interface box (7) is installed for actuator (10) which is connected to the housing section (22) of engine (1) without projecting above the outer circumference of housing section (21) of hydraulic unit (3).

15. Electrohydraulic actuator (10) according to claim 1, characterised in that sections of housing (21, 22) are aligned coaxially with working direction X and with each another.
